(19) United States
(12) Patent Application Publication
(10) Pub. No.: US 2026/0077731 A1
(43) Pub. Date: Mar. 19, 2026

(54) DEFLECTOR DEVICES FOR OFF-ROAD VEHICLES AND RELATED METHODS

(71) Applicants: Gregory Brown, Morinville (CA); Sylvie Brown, Morinville (CA)

(72) Inventors: Gregory Brown, Morinville (CA); Sylvie Brown, Morinville (CA)

(21) Appl. No.: 19/316,200

(22) Filed: Sep. 2, 2025

Related U.S. Application Data
(60) Provisional application No. 63/695,003, filed on Sep. 16, 2024.

(51) Int. Cl. B60R 19/16; B60R 19/02; B60R 19/24

(52) U.S. Cl. CPC B60R 19/16; B60R 19/24; B60R 2019/026

(57) ABSTRACT

A deflector device for an off-road vehicle is provided, in particular, for off-road vehicles comprising a roll cage and a roof. The deflector device may comprise a deflector bar that angles upwards from the roll cage over a front edge of the roof such that any trees or branches that ride up the roll cage will be deflected away and prevented from embedding between the front edge and the roll cage. Related methods of preventing damage to off-road vehicles are also provided.

### TECHNICAL FIELD

The present disclosure claims priority to U.S. Provisional Patent Application No. 63/695,003 , filed Sep. 16, 2024, the entire content of which is herein incorporated by reference.

### TECHNICAL FIELD

The present disclosure relates generally to vehicle parts and accessories. More particularly, the present disclosure relates to deflector devices for off-road vehicles and related methods.

### BACKGROUND

Off-road vehicles such as all-terrain vehicles (ATVs) and utility task vehicles (UTVs) are designed for off-road use on rough terrain. ATVs and UTVs can be equipped with roll cages which are designed to protect the operator in the event the vehicle rolls. A roof may be attached to the roll cage to further protect the operator from the elements. ATV/UTV roofs are typically made of plastic or aluminum and may be bolted or otherwise mounted to the roll cage. Most roofs have an extended front edge, otherwise known as a lip or drip edge, that projects outwards from the front of the vehicle to protect the user from rain.

When ATVs and UTVs are driven through areas dense with brush or trees, trees and branches that contact the roll cage can ride up and become embedded in the space between the drip edge and the roll cage. In particular, the corners of the drip edge sit above the roll cage and produce vulnerable access points for trees and branches to be pulled between the roof and the roll cage. As the vehicle drives forward and the tree or branch is forced between the roof and the roll cage, the gap between the roof and the roll cage expands. This can cause excessive tension on the roof and the bolt points between the roof and the roll cage. Under extreme loads, the roof structure could fail, resulting in chipped roof edges, cracks, and splits. Under less extreme loads, the initial damage may be smaller (and may not even be noticeable to the operator), but the damage may become more severe the next time a branch becomes embedded in the widened gap. Damage to the roof structure may be particularly severe during cold weather as the plastic of the roof can become brittle, making it more susceptible to impact damage.

There is currently a lack of commercially available products that protect the roof lines of off-road vehicles from damage from trees and branches.

### SUMMARY

In one aspect, there is provided a deflector device for an off-road vehicle having a roll cage and a roof, comprising: a base having a longitudinal axis, an upper end, a lower end, a top face, and a bottom face, the bottom face attachable to the roll cage of the off-road vehicle proximate the roof; and a deflector bar comprising an elongate body having a first end and a second end, the first end connected to the top face of the base proximate the lower end of the base and the second end projecting longitudinally outwards past the upper end of the base, wherein the deflector bar extends upwards from the first end towards the second end at an acute angle with respect to the longitudinal axis such that the second end is laterally spaced from the top face of the base.

In some embodiments, the second end of the deflector bar curves downwards towards the top face of the base.

In some embodiments, the acute angle is between 15 and 30 degrees.

In some embodiments, the base comprises one or more holes extending from the top face to the bottom face, each of the one or more holes dimensioned to receive a respective fastener therethrough.

In some embodiments, the deflector device further comprises a support bracket positioned proximate the upper end of the base, the support bracket interconnecting the base and the deflector bar.

In some embodiments, the height of the support bracket is selected based on the acute angle between the deflector bar and the longitudinal axis.

In some embodiments, the base, the deflector bar, and the support bracket are welded to one another.

In some embodiments, the base, the deflector bar, and the support bracket are integral with one another.

In another aspect, there is provided a deflector device for an off-road vehicle having a roll cage and a roof, comprising: a deflector bar attachable to the roll cage of the off-road vehicle proximate the roof, the deflector bar comprising an elongate body having a first end and a second end, the first end connecting to the roll cage and the second end extending upwards from the first end at an acute angle such that the second end is laterally spaced from the roll cage and extends longitudinally over a front edge of the roof.

In some embodiments, the second end of the deflector bar curves downwards towards the roll cage.

In some embodiments, the acute angle is between 15 and 30 degrees.

In some embodiments, the deflector device further comprises a support bracket that interconnects the deflector bar and the roll cage.

In some embodiments, the first end of the deflector bar is welded to the roll cage.

In another aspect, there is provided a method for preventing damage to an off-road vehicle having a roll cage and a roof attached to the roll cage, comprising: providing a deflector device comprising a deflector bar; and attaching the deflector device to the roll cage proximate the roof such that the deflector bar extends over a front edge of the roof.

In some embodiments, the deflector device is attached to the roll cage by welding the deflector bar directly to the roll cage.

In some embodiments, the deflector device further comprises a base and the deflector device is attached to the roll cage via the base.

In some embodiments, the base is attached to the roll cage using one or more fasteners.

In some embodiments, the method further comprises applying a sealant between the roll cage and the base before the base is attached to the roll cage.

In some embodiments, the deflector device further comprises a support bracket that interconnects the deflector bar and the base or the roll cage.

In some embodiments, providing the deflector device comprises providing two deflector devices, and wherein the respective bases of the two deflector devices are attached on opposite sides of the roll cage.

Other aspects and features of the present disclosure will become apparent, to those ordinarily skilled in the art, upon review of the following description of specific embodiments of the disclosure.

### BRIEF DESCRIPTION OF THE DRAWINGS

FIG. 1 is a top perspective view of an example deflector device, according to some embodiments;

FIG. 2A is a top view of a base of the deflector device of FIG. 1;

FIG. 2B is a side view of a deflector bar of the deflector device of FIG. 1;

FIG. 2C is a top perspective view of a support bracket of the deflector device of FIG. 1;

FIG. 3 is a perspective side view of the deflector device of FIG. 1, shown secured to a roll cage of an offroad vehicle;

FIG. 4 is a front view of an offroad vehicle with a pair of the deflector devices of FIG. 1 installed thereon;

FIGS. 5A and 5B are side and top views, respectively, of another embodiment of a deflector device; and

FIG. 6 is a flowchart of an example method for preventing damage to an off-road vehicle, according to some embodiments.

### DETAILED DESCRIPTION

Generally, the present disclosure provides a deflector device for off-road vehicles. Also provided are related methods.

As used herein and in the appended claims, the singular forms of “a”, “an”and “the”include plural referents unless the context clearly dictates otherwise.

As used herein, the terms “top” and “bottom”, “upper” and “lower”, “upward” and “downward” and the like refer to the typical orientation of the deflector device when it is installed on a vehicle; however, a person skilled in the art will recognize that these are relative terms that are used for ease of description only and do not limit the orientation of deflector devices described herein.

The deflector devices disclosed herein may be used to prevent damage to vehicles. In some embodiment, the vehicles are off-road vehicles that comprise a roll cage with a roof attached thereto. As used herein, “off-road vehicle” is intended to be inclusive of any motorized vehicle with a roll cage and roof including, but not limited to, ATVs and UTVs. However, it will be understood that embodiments are not limited to a specific vehicle type and the devices disclosed herein can be used with any vehicle with a similar or equivalent structure.

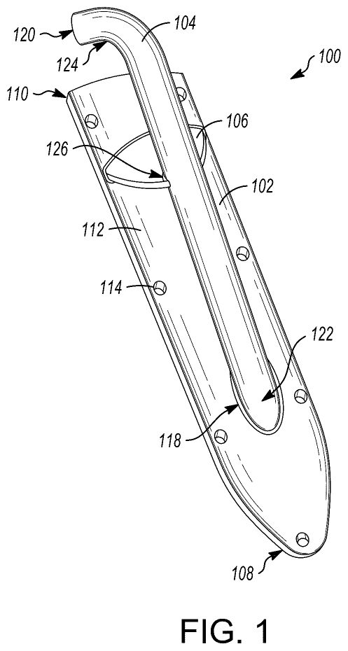

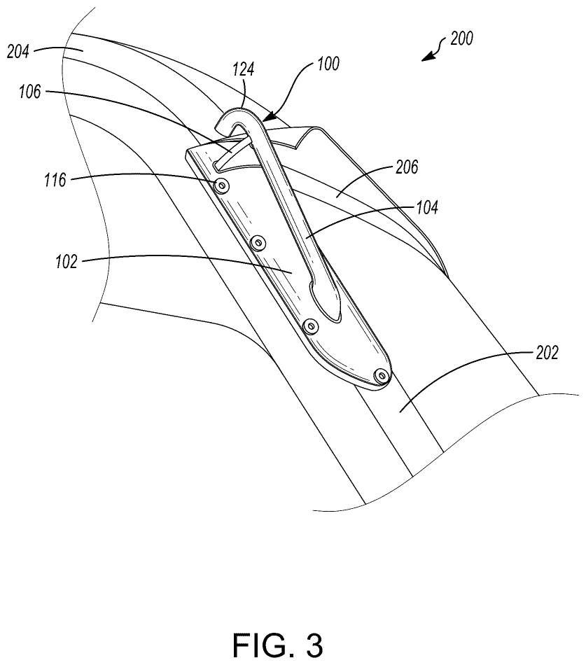

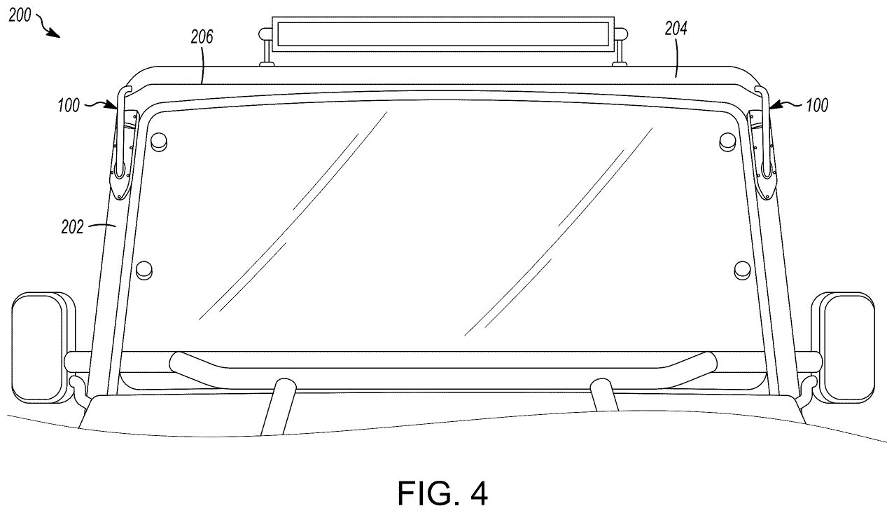

An example deflector device 100 will be discussed with reference to FIGS. 1-4. The deflector device 100 in this embodiment comprises a base 102, a deflector bar 104, and a support bracket 106. FIGS. 3 and 4 show the device 100 installed on an off-road vehicle 200 with a roll cage 202 and a roof 204. The roof 204 has a projecting front edge 206 (also referred to herein as a lip or drip edge). In FIGS. 3 and 4, the vehicle 200 is a UTV.

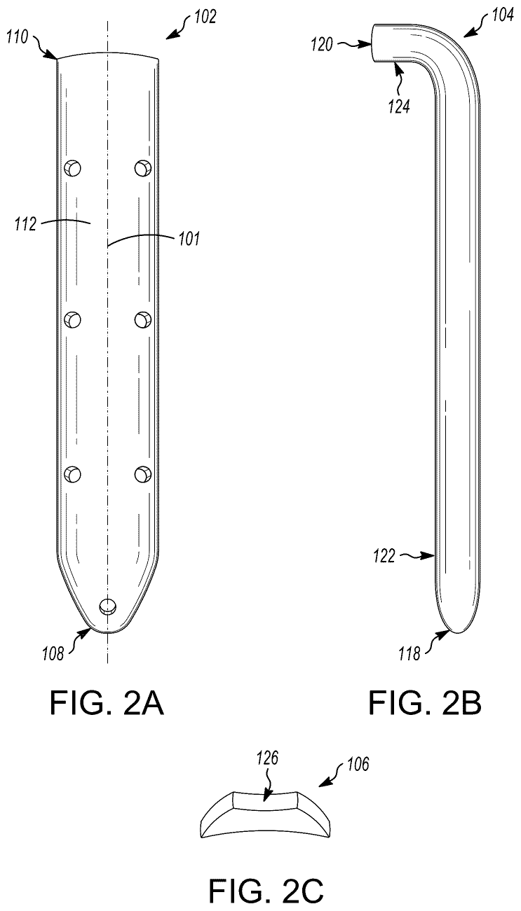

The base 102 will be discussed with reference to FIGS. 1 and 2A. The base 102 may be made of a relatively thin, flat piece of material. The material of the base 102 may be metal, such as steel or stainless steel, or may be any other suitable material. The base 102 has a longitudinal axis 101 (visible in FIG. 2A), a first (lower) end 108, a second (upper) end 110, a top face 112, and a bottom face (not visible). The base 102 in this embodiment is approximately rectangular in shape with the lower end 108 curving outwards and the upper end 110 curving inwards. In other embodiments, the base 102 may be any other suitable shape.

The bottom face of the base 102 is attachable to the roll cage 202 of the vehicle 200 proximate the roof 204. As shown in FIGS. 3-5, the sides of the base 102 may curve slightly downwards to allow the base 102 to conform to the shape of the roll cage 202. The base 102 may comprise one or more holes 114 (visible in FIG. 1) extending from the top face 112 to the bottom face. In this embodiment, the base 102 has seven holes 114. Each hole 114 is dimensioned to receive a respective fastener 116 (visible in FIG. 3-5) therethrough to attach the base 102 to the roll cage 202. In this embodiment, each hole 114 is about 3/16″. In some embodiments, the fasteners 116 are stainless steel rivets. In other embodiments, the fasteners may be any other suitable type of fastener. As shown in FIG. 1, a plurality of holes 114 may be provided around the circumference of the base 102 to receive respective fasteners 116 therethrough to securely attach the base 102 to the roll cage 202.

In other embodiments, the base 102 may be attached to the roll cage 202 by any other suitable attachment means. The base 102 may be attached to the roll cage 202 in either a permanent or a temporary manner.

In alternative embodiments, the base may be omitted and the deflector bar 104 may be connected directly to the roll cage 202. The deflector bar 104 may be directly connected to the roll cage 202 via welding. In other embodiments, the deflector bar may be directly connected to the roll cage 202 by any other suitable means, such as by one or more fasteners. Alternatively, the deflector bar 104 and at least a portion of the roll cage 202 may be integrally formed with one another, for example, by moulding or three-dimensional (3D) printing.

Referring now to FIGS. 1 and 2B, the deflector bar 104 comprises an elongate body having a first (lower) end 118 and a second (upper) end 120. In this embodiment, the deflector bar 104 is an approximately cylindrical rod. In other embodiments, the deflector bar 104 may be a tube. In other embodiments, the bar 104 may be any other suitable shape. The bar 104 may be comprised of metal, such as steel or stainless steel, or any other suitable material. The bar 104 be made of the same material as the base 102 or a different material.

The first end 118 of the deflector bar 104 may be connected to the top face 112 of the base 102 proximate its lower end 108. In some embodiments, the bar 104 may have a tapered portion 122 at its first end 118 to facilitate connection to the base 102. In this embodiment, the first end 118 is connected to the base 102 via welding. In other embodiments, the first end 118 may be connected to the base 102 by any other suitable means, such as by one or more fasteners. Alternatively, the deflector bar 104 and the base 102 may be integrally formed with one another, for example, by moulding or three-dimensional (3D) printing.

The deflector bar 104 extends upwards from the first end 118 towards the second end 120 at an acute angle with respect to the longitudinal axis 101 of the base 102, thereby spacing the second end 120 laterally from the top face 112 of the base 102. The angle between the deflector bar 104 and the longitudinal axis 101 may be less than 45°, less than 30°, or between about 15° and about 30°. The size of the angle may be variable and may be selected based on the relevant dimensions of the vehicle 200, such as the length of front edge 206 and the size of the gap between the roof 204 and roll cage 202, to allow the second end 120 of the deflector bar 104 to extend over the front edge 206 of the roof 204 as shown in FIGS. 3 and 4.

The second end 120 projects longitudinally outwards past the upper end 110 of the base 102 to allow the deflector bar 104 to extend over the front edge 206 of the roof 204. The second end 120 in this embodiment curves downwards towards the longitudinal axis 101 (i.e. towards the top face 112 of the base 102). The deflector bar 104 may therefore comprise a curved portion 124 proximate the second end 120. The curved portion 124 may be approximately perpendicular, or at another suitable angle, with respect to the longitudinal axis 101 of the base 102. Both the overall length of the deflector bar 104 and the length of the curved portion 124 may be varied to accommodate different vehicles to ensure that the curved portion 124 curves over the front edge 206 of the roof 204.

Referring now to FIGS. 1 and 2C, the support bracket 106 is configured to provide additional support to the deflector bar 104 on the base 102. The support bracket 106 may be positioned proximate the upper end 110 of the base 102, below the deflector bar 104, and may interconnect the base 102 and the deflector bar 104. In this embodiment, the support bracket 106 is approximately triangular in shape and has a groove 126 for receiving the deflector bar 104. In other embodiments, the support bracket 106 may be any other suitable shape. The height of the support bracket 106 is variable. The height of the support bracket 106 may be selected based on the required angle of the deflector bar 104 as discussed above.

In alternative embodiments, the support bracket 106 may be omitted, for example in embodiments in which the angle between the deflector bar 104 and the base 102 is very small.

The support bracket 106 may be made of metal, such as steel or stainless steel, or any other suitable material. The support bracket 106 in this embodiment is the same material as the base 102 and the deflector bar 104. In other embodiments, the support bracket 106 may be a different material. In this embodiment, the support bracket 106 is welded to both the base 102 and the deflector bar 104. In other embodiments, the support bracket 106 may be attached to the base 102 and the deflector bar 104 by any other suitable means. Alternatively, the base 102, the deflector bar 104, and the support bracket 106 may all be integral with one another.

Other variations of the device 100 are possible and a person skilled in the art will understand that the shape and dimensions of the device 100 may vary from that shown in FIGS. 1-4 to adapt the device 100 for different vehicles as appropriate.

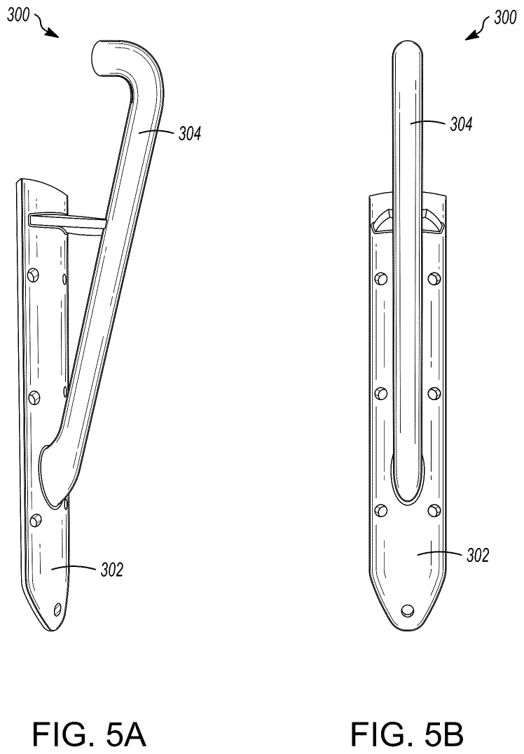

An example of another device 300 with different dimensions from the device 100 is shown in FIGS. 5A and 5B. The device 300 has a narrower base 302 and a longer deflector bar 304 that extends farther past the upper end of the base 302. This embodiment is configured for vehicles with a higher roof line and a narrower contact area on the roll cage due to the presence of a windshield rubber seal.

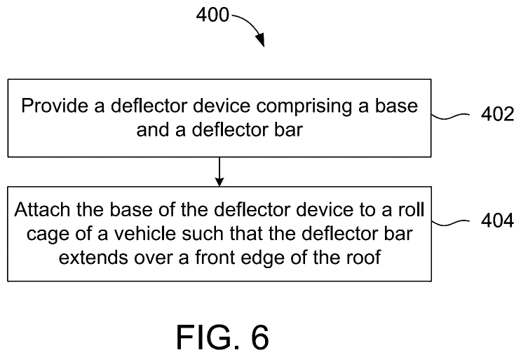

FIG. 6 is a flowchart of an example method 400 for protecting an off-road vehicle from damage, according to some embodiments. The method 400 will be discussed with reference to the device 100 and the vehicle 200 as described above. However, it will be understood that the same method 400 can be used with any alternative embodiment of the device 100, including the device 300.

At block 402, a deflector device 100 is provided comprising a base 102 and a deflector bar 104. The deflector device 100 in this embodiment also comprises a support bracket 106. The deflector device 100 may be any embodiment of the deflector device 100 discussed above. The term “provide” in this context refers to making, manufacturing, acquiring, purchasing, or otherwise obtaining the deflector device 100. In some embodiments, a pair of devices 100 may be provided as a kit, along with instructions for installation of the devices onto a vehicle.

At block 404, the base of the deflector device 100 is attached to the roll cage 202 proximate the roof 204 such that the deflector bar 104 extends over the front edge 206 of the roof 204. As shown in FIGS. 3 and 4, the second end 120 and curved portion 124 of the deflector bar 104 extend over the front edge 206.

In some embodiments, the device 100 may be attached to the roll cage 202 by drilling holes in the roll cage 202 that align with the holes 114 in the base 102 and installing fasteners 116 through the aligned holes. In this embodiment, the fasteners 116 are rivets. In other embodiments, the device 100 may be attached to the roll cage 202 by any other suitable means. In some embodiments, a sealant such as silicon may be applied between the roll cage 202 and the bottom face of the base 102 prior to installing the fasteners 116 to prevent water from entering between the device 100 and the roll cage 202. In some embodiments, a pair of devices 100 are attached on opposite sides of the roll cage 202 as shown in FIG. 4.

Once the devices 100 are installed on the vehicle 200, an operator can drive the vehicle 200 off-road and any trees or branches that ride up the roll cage 202 will be deflected away from the vulnerable corners of the front edge 206 of the roof 204 by the presence of the deflector bar 104, thereby preventing the trees/branches from embedding between the front edge 206 and the roll cage 202. The device 100 therefore prevents damage to the roof 204 and extends the life of the roof 204 without requiring expensive repairs or replacement. The device 100 is also suitable for use in all seasons, including fall and winter in which the colder temperatures may render the roof 204 more brittle and prone to damage. Moreover, the device 100 does not hinder visibility when driving and has a minimal effect on the appearance and aerodynamics of the vehicle 200.

The method 400 can also be adapted for embodiments of the disclosed deflector device without a base. In these embodiments, the deflector bar may be attached directly to the roll cage, for example, via welding. In this embodiment, the support bracket may also be welded to the roll cage.

Although a few embodiments have been shown and described, it will be appreciated by those skilled in the art that various changes and modifications can be made to those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof.

1. A deflector device for an off-road vehicle having a roll cage and a roof, comprising:
a base having a longitudinal axis, an upper end, a lower end, a top face, and a bottom face, the bottom face attachable to the roll cage of the off-road vehicle proximate the roof; and
a deflector bar comprising an elongate body having a first end and a second end, the first end connected to the top face of the base proximate the lower end of the base and the second end projecting longitudinally outwards past the upper end of the base, wherein the deflector bar extends upwards from the first end towards the second end at an acute angle with respect to the longitudinal axis such that the second end is laterally spaced from the top face of the base.

2. The deflector device of claim 1, wherein the second end of the deflector bar curves downwards towards the top face of the base.

3. The deflector device of claim 1, wherein the acute angle is between 15 and 30 degrees.

4. The deflector device of claim 1, wherein the base comprises one or more holes extending from the top face to the bottom face, each of the one or more holes dimensioned to receive a respective fastener therethrough.

5. The deflector device of claim 1, further comprising a support bracket positioned proximate the upper end of the base, the support bracket interconnecting the base and the deflector bar.

6. The deflector device of claim 5, wherein the height of the support bracket is selected based on the acute angle between the deflector bar and the longitudinal axis.

7. The deflector device of claim 5, wherein the base, the deflector bar, and the support bracket are welded to one another.

8. The deflector device of claim 5, wherein the base, the deflector bar, and the support bracket are integral with one another.

9. A deflector device for an off-road vehicle having a roll cage and a roof, comprising:
a deflector bar attachable to the roll cage of the off-road vehicle proximate the roof, the deflector bar comprising an elongate body having a first end and a second end, the first end connecting to the roll cage and the second end extending upwards from the first end at an acute angle such that the second end is laterally spaced from the roll cage and extends longitudinally over a front edge of the roof.

10. The deflector device of claim 9, wherein the second end of the deflector bar curves downwards towards the roll cage.

11. The deflector device of claim 9, wherein the acute angle is between 15 and 30 degrees.

12. The deflector device of claim 9, further comprising a support bracket that interconnects the deflector bar and the roll cage.

13. The deflector device of claim 9, wherein the first end of the deflector bar is welded to the roll cage.

14. A method for preventing damage to an off-road vehicle having a roll cage and a roof attached to the roll cage, comprising:
providing a deflector device comprising a deflector bar; and
attaching the deflector device to the roll cage proximate the roof such that the deflector bar extends over a front edge of the roof.

15. The method of claim 14, wherein the deflector device is attached to the roll cage by welding the deflector bar directly to the roll cage.

16. The method of claim 14, wherein the deflector device further comprises a base and the deflector device is attached to the roll cage via the base.

17. The method of claim 16, wherein the base is attached to the roll cage using one or more fasteners.

18. The method of claim 16, further comprising applying a sealant between the roll cage and the base before the base is attached to the roll cage.

19. The method of claim 14, wherein the deflector device further comprises a support bracket that interconnects the deflector bar and the base or the roll cage.

20. The method of claim 14, wherein providing the deflector device comprises providing two deflector devices, and wherein the respective bases of the two deflector devices are attached on opposite sides of the roll cage.
